(19) United States
(12) Patent Application Publication
(10) Pub. No.: US 2018/0301758 A1
(43) Pub. Date: Oct. 18, 2018

(54) NONAQUEOUS ELECTROLYTE SOLUTION AND ELECTRICITY STORAGE DEVICE USING SAME

(71) Applicant: UBE INDUSTRIES, LTD., Ube-shi (JP)

(72) Inventors: Koji ABE, Ota-ku (JP); Masahide KONDO, Takaishi-shi (JP)

(73) Assignee: UBE INDUSTRIES, LTD., Ube-shi (JP)

(21) Appl. No.: 15/766,219

(22) PCT Filed: Oct. 5, 2016
(86) PCT No.: PCT/JP2016/079612

§ 371 Date: Apr. 5, 2018

(30) Foreign Application Priority Data
Oct. 9, 2015 (JP) 2015-201576

(51) Int. Cl. H01M 10/0569; H01G 11/60; H01G 11/62; H01G 11/64; H01M 10/0568; H01M 10/0525; H01M 4/36; H01M 4/38; H01M 4/587; H01M 4/505; H01M 4/525

(52) U.S. Cl. CPC H01M 10/0569; H01G 11/60; H01G 11/62; H01G 11/64; H01M 10/0568; H01G 11/32; H01M 4/364; H01M 4/386; H01M 4/587; H01M 4/505; H01M 4/525; H01M 10/0525

(57) ABSTRACT

The present invention relates to a nonaqueous electrolytic solution capable of improving charging storage properties and discharging storage properties in the high-temperature environment and provides a nonaqueous electrolytic solution for an energy storage device, which is a nonaqueous electrolytic solution having an electrolyte salt dissolved in a nonaqueous solvent, the nonaqueous electrolytic solution containing 0.1 to 4% by mass of 1,3-dioxane and further containing 0.1 to 4% by mass of a compound having a carbon-carbon triple bond represented by the following general formula (I); and an energy storage device using the same.

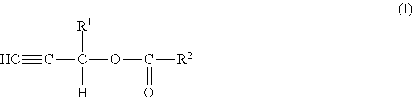

In the formula, R¹ represents a hydrogen atom or a methyl group, and R² represents a methyl group, an ethyl group, a methoxy group, or an ethoxy group.

### TECHNICAL FIELD

The present invention relates to a nonaqueous electrolytic solution capable of improving charging storage properties and discharging storage properties of an energy storage device in the high-temperature environment and an energy storage device using the same.

### BACKGROUND ART

A lithium ion secondary battery and a lithium ion capacitor have been recently watched as a power source for a vehicle, such as an electric vehicle, a hybrid car, etc., or a power source for idle reduction.

As an electrolytic solution of a lithium secondary battery, a nonaqueous electrolytic solution in which an electrolyte, such as LiPF₆, LiBF₄, etc., is dissolved in a cyclic carbonate, such as ethylene carbonate, propylene carbonate, etc., and a linear carbonate, such as dimethyl carbonate, diethyl carbonate, ethyl methyl carbonate, etc., is used.

In order to improve battery characteristics of such a lithium secondary battery, such as cycle properties, storage properties, etc., a variety of investigations regarding a nonaqueous solvent or an electrolyte to be used for such a nonaqueous electrolytic solution are made.

For example, PTL 1 proposes a nonaqueous electrolyte secondary battery provided with a positive electrode, a negative electrode, and a nonaqueous electrolyte, in which the nonaqueous electrolyte includes a nonaqueous solvent, an electrolyte salt, 1,3-dioxane, and a sulfonic acid ester compound. According to PTL 1, it is mentioned that an initial capacity, cycle properties, and storage properties of a secondary battery capable of achieving high-voltage charging at which a potential of a positive electrode active material is more than 4.3 V can be improved.

Now, in the case where the lithium secondary battery is kept in a charged state over a long period of time in the high-temperature environment (for example, in the environment where the temperature is higher than 50° C., such as the inside of a car in midsummer), there is a possibility that in the battery, a part of the nonaqueous solvent causes oxidative decomposition on the surface of a positive electrode, thereby causing deposition of decomposed products or electrolyte depletion due to generation of a gas. If that is the case, there is involved such a problem that interfacial resistance of the positive electrode increases, thereby worsening desired electrochemical characteristics of the battery.

Meanwhile, in the case where the lithium secondary battery is kept in a discharged state over a long period of time in the high-temperature environment, there is a possibility that a surface film on the surface of a negative electrode is dissolved, whereby an active surface of the negative electrode locally appears. If that is the case, the active surface of the negative electrode reacts with a part of the nonaqueous solvent to cause self-discharge, so that the potential of the negative electrode increases. In particular, a series of reactions are accelerated in the high-temperature environment, and therefore, there is involved such a problem that the battery becomes in an over-discharged state, and the negative electrode collector becomes to dissolve, thereby worsening desired electrochemical characteristics of the battery.

### CITATION LIST

### Patent Literature

PTL 1: JP 2009-140919 A

### SUMMARY OF INVENTION

### Problem to be Solved by the Invention

An object of the present invention is to provide a nonaqueous electrolytic solution capable of improving charging storage properties and discharging storage properties of an energy storage device in the high-temperature environment and an energy storage device using the same.

### Solution to Problem

In PTL 1, 1,3-dioxane and a sulfonic acid ester are mixed and added, and a certain effect regarding the charging storage properties is obtained; however, the improvement of the discharging storage properties in the high-temperature environment is neither described nor suggested, and it is the actual situation that a satisfactory effect is not obtained.

Then, in order to solve the aforementioned problem, the present inventors made extensive and intensive investigations. As a result, it has been found that in a nonaqueous electrolytic solution having an electrolyte salt dissolved in a nonaqueous solvent, when the nonaqueous electrolytic solution contains 0.1 to 4% by mass of 1,3-dioxane and further contains 0.1 to 4% by mass of at least one compound having a carbon-carbon triple bond represented by the general formula (I) described below, the charging storage properties and the discharging storage properties in the high-temperature environment are remarkably improved, thereby leading to accomplishment of the present invention.

Specifically, the present invention provides the following (1) and (2).

(1) A nonaqueous electrolytic solution having an electrolyte salt dissolved in a nonaqueous solvent, the nonaqueous electrolytic solution containing 0.1 to 4% by mass of 1,3-dioxane and further containing 0.1 to 4% by mass of a compound having a carbon-carbon triple bond represented by the following general formula (I).

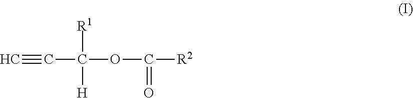

In the formula, R¹ represents a hydrogen atom or a methyl group, and R² represents an alkyl group selected from a methyl group and an ethyl group, or an alkoxy group selected from a methoxy group and an ethoxy group.

(2) An energy storage device including a positive electrode, a negative electrode, and a nonaqueous electrolytic solution having an electrolyte salt dissolved in a nonaqueous solvent, the nonaqueous electrolytic solution being the nonaqueous electrolytic solution set forth above in (1).

### Advantageous Effects of Invention

In accordance with the present invention, it is possible to provide a nonaqueous electrolytic solution capable of improving charging storage properties and discharging storage properties of an energy storage device in the high-temperature environment and an energy storage device using the same, such as a lithium battery, etc.

### DESCRIPTION OF EMBODIMENTS

### [Nonaqueous Electrolytic Solution]

The nonaqueous electrolytic solution of the present invention is a nonaqueous electrolytic solution having an electrolyte salt dissolved in a nonaqueous solvent, the nonaqueous electrolytic solution containing 0.1 to 4% by mass of 1,3-dioxane and further containing 0.1 to 4% by mass of a compound having a carbon-carbon triple bond represented by the aforementioned general formula (I).

Though reasons why the nonaqueous electrolytic solution of the present invention is able to improve the charging storage properties and the discharging storage properties in the high-temperature environment are not always elucidated yet, the following may be considered.

In the present invention, the compound having a specified characteristic group (an ester group or a carbonate group) and a carbon-carbon triple bond, which is represented by the aforementioned general formula (I) and which is used in combination with 1,3-dioxane, is electrochemically reduced on the negative electrode side, to form a surface film; however, dissolution and regeneration of the surface film proceed in the high-temperature environment, and therefore, such becomes a main cause of an increase of interfacial resistance of the negative electrode. Meanwhile, while 1,3-dioxane is electrochemically reduced on the negative electrode side, it does not form a surface film, and therefore, when the 1,3-dioxane remains in the electrolytic solution, it is reduced on the surface of the negative electrode, and such becomes a main cause of self-discharge. However, when a combination of a specified amount of the 1,3-dioxane with a specified amount of the compound having a carbon-carbon triple bond is used, in the process of forming a surface film of the compound having a carbon-carbon triple bond, a part of the 1,3-dioxane is taken in the surface film, whereby a firm complex surface film is formed. The foregoing complex surface film is high in durability in the high-temperature environment, and therefore, the self-discharge at the time of long-term storage is suppressed.

Furthermore, the 1,3-dioxane remaining in the electrolytic solution acts on the surface of the positive electrode in cooperation with a part of a reductive decomposition product of the specified compound having a carbon-carbon triple bond, thereby forming a surface film having high thermal stability, and therefore, the increase of resistance at the time of charging storage is suppressed. As a result, it may be considered that the nonaqueous electrolytic solution of the present invention is able to improve both the charging storage properties and the discharging storage properties in the high-temperature environment.

In the nonaqueous electrolytic solution of the present invention, the content of 1,3-dioxane is preferably 0.1 to 4% by mass in the nonaqueous electrolytic solution. When the foregoing content is 4% by mass or less, there is less concern that a surface film is excessively formed on the electrode and the electrochemical characteristics are worsened. In addition, when the content is 0.1% by mass or more, the formation of a surface film is sufficient, and the effect for improving the charging storage properties is enhanced. The foregoing content is preferably 0.2% by mass or more, and more preferably 0.3% by mass or more in the nonaqueous electrolytic solution. In addition, an upper limit thereof is preferably 3.8% by mass or less, more preferably 3.5% by mass or less, and still more preferably 3.2% by mass or less.

The compound having a carbon-carbon triple bond, which is included in the nonaqueous electrolytic solution of the present invention, is represented by the following general formula (I).

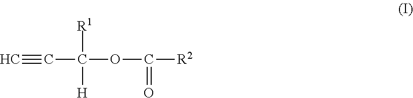

In the formula, R¹ represents a hydrogen atom or a methyl group, and R² represents an alkyl group selected from a methyl group and an ethyl group, or an alkoxy group selected from a methoxy group and an ethoxy group.

In the aforementioned general formula (I), R¹ represents a hydrogen atom or a methyl group, and more preferably a hydrogen atom.

R² represents an alkyl group selected from a methyl group and an ethyl group, or an alkoxy group selected from a methoxy group and an ethoxy group, preferably an alkoxy group selected from a methoxy group and an ethoxy group, and still more preferably a methoxy group.

As the compound having a carbon-carbon triple bond represented by the aforementioned general formula (I), specifically, the following compounds are suitably exemplified.

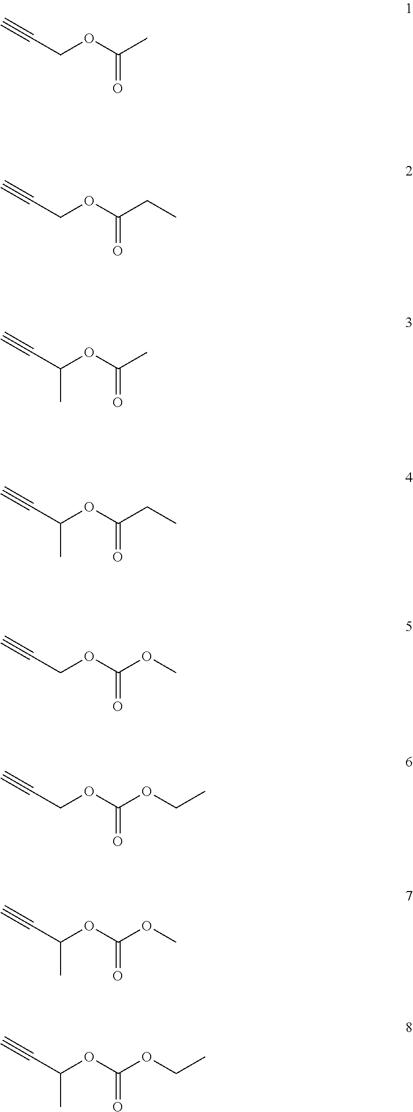

Among the aforementioned compounds, 2-propynyl acetate (Compound 1), 2-propynyl propionate (Compound 2), 2-propynyl methyl carbonate (Compound 5), and 2-propynyl ethyl carbonate (Compound 6) are more preferred, and 2-propynyl methyl carbonate (Compound 5) and 2-propynyl ethyl carbonate (Compound 6) are still more preferred. When the compound having a carbon-carbon triple bond represented by the aforementioned general formula (I) has a carbonate group as the characteristic group in the structure, the charging storage properties and the discharging storage properties in the high-temperature environment are much more improved, and hence, such is preferred.

The compound represented by the general formula (I) may be used solely or in combination of two or more thereof.

In the nonaqueous electrolytic solution of the present invention, the total content of the compound having a carbon-carbon triple bond represented by the aforementioned general formula (I), which is contained in the nonaqueous electrolytic solution, is preferably 0.1 to 4% by mass in the nonaqueous electrolytic solution. When the foregoing content is 4% by mass or less, there is less concern that a surface film is excessively formed on the electrode and the electrochemical characteristics are worsened. In addition, when the content is 0.1% by mass or more, the formation of a surface film is sufficient, and the effect for improving the charging storage properties is enhanced. The foregoing content is preferably 0.2% by mass or more, and more preferably 0.3% by mass or more in the nonaqueous electrolytic solution. In addition, an upper limit thereof is preferably 3.5% by mass or less, more preferably 3.3% by mass or less, and still more preferably 3.2% by mass or less.

In the nonaqueous electrolytic solution of the present invention, the total amount (Cd+Ct) of the content Cd of 1,3-dioxane and the content Ct of the compound having a carbon-carbon triple bond represented by the aforementioned general formula (I), both of which are contained in the nonaqueous electrolytic solution, is preferably 0.3% by mass or more, more preferably 0.5% by mass or more, and still more preferably 0.6% by mass or more. An upper limit thereof is preferably 7.5% by mass or less, more preferably 7% by mass or less, and still more preferably 6% by mass or less.

Cd is preferably more than Ct, and a mass ratio (Cd/Ct) of the content Cd of 1,3-dioxane to the content Ct of the compound having a carbon-carbon triple bond is preferably 51/49 to 99/1, more preferably 55/45 to 95/5, and still more preferably 60/40 to 90/10. When the mass ratio of the content of 1,3-dioxane to the content of the compound having a carbon-carbon triple bond falls within the aforementioned range, the charging storage properties and the discharging storage properties in the high-temperature environment are much more improved, and hence, such is preferred.

In the nonaqueous electrolytic solution of the present invention, when 1,3-dioxane and the compound having a carbon-carbon triple bond represented by the aforementioned general formula (I) are combined with a nonaqueous solvent and an electrolyte salt, and further other additives as described below, a peculiar effect such that the effect for improving the charging storage properties and the discharging storage properties in the high-temperature environment is synergistically improved is revealed.

### [Nonaqueous Solvent]

As the nonaqueous solvent which is used for the nonaqueous electrolytic solution of the present invention, one or more selected from a cyclic carbonate, a linear ester, a lactone, an ether, and an amide are suitably exemplified. In order to synergistically improve the electrochemical characteristics in the high-temperature environment, it is preferred that a linear ester is included; it is more preferred that a linear carbonate is included; it is still more preferred that both a cyclic carbonate and a linear ester are included; and it is especially preferred that both a cyclic carbonate and a linear carbonate are included.

The term “linear ester” is used as a concept including a linear carbonate and a linear carboxylic acid ester.

Examples of the cyclic carbonate include one or more selected from ethylene carbonate (EC), propylene carbonate (PC), 1,2-butylene carbonate, 2,3-butylene carbonate, 4-fluoro-1,3-dioxolan-2-one (FEC), trans- or cis-4,5-difluoro-1,3-dioxolan-2-one (the both will be hereunder named generically as “DFEC”), vinylene carbonate (VC), vinyl ethylene carbonate (VEC), and 4-ethynyl-1,3-dioxolan-2-one (EEC). One or more selected from ethylene carbonate (EC), propylene carbonate (PC), 4-fluoro-1,3-dioxolan-2-one (FEC), vinylene carbonate (VC), and 4-ethynyl-1,3-dioxolan-2-one (EEC) are more suitable.

The use of at least one of the aforementioned cyclic carbonates having an unsaturated bond, such as a carbon-carbon double bond, a carbon-carbon triple bond, etc., or a fluorine atom is preferred because the electrochemical characteristics in the high-temperature environment are much more improved. It is more preferred that both a cyclic carbonate having an unsaturated bond, such as a carbon-carbon double bond, a carbon-carbon triple bond, etc., and a cyclic carbonate having a fluorine atom are included. As the cyclic carbonate having an unsaturated bond, such as a carbon-carbon double bond, a carbon-carbon triple bond, etc., VC, VEC, or EEC is more preferred, and as the cyclic carbonate having a fluorine atom, FEC or DFEC is more preferred.

The content of the cyclic carbonate having an unsaturated bond, such as a carbon-carbon double bond, a carbon-carbon triple bond, etc., is preferably 0.07% by volume or more, more preferably 0.2% by volume or more, and still more preferably 0.7% by volume or more relative to the total volume of the nonaqueous solvent, and an upper limit thereof is preferably 7% by volume or less, more preferably 4% by volume or less, and still more preferably 2.5% by volume or less. When the foregoing content falls within the aforementioned range, the electrochemical characteristics in the high-temperature environment can be much more improved without impairing the Li ion permeability, and hence, such is preferred.

The content of the cyclic carbonate having a fluorine atom is preferably 0.07% by volume or more, more preferably 3% by volume or more, and still more preferably 4% by volume or more relative to the total volume of the nonaqueous solvent, and an upper limit thereof is 35% by volume or less, more preferably 26% by volume or less, and still more preferably 15% by volume or less. When the foregoing content falls within the aforementioned range, the electrochemical characteristics in the high-temperature environment can be much more improved without impairing the Li ion permeability, and hence, such is preferred.

In the case where the nonaqueous solvent includes both the aforementioned cyclic carbonate having an unsaturated bond and the aforementioned cyclic carbonate having a fluorine atom, the content of the aforementioned cyclic carbonate having an unsaturated bond is preferably 0.2% by volume or more, more preferably 3% by volume or more, and still more preferably 7% by volume or more relative to the content of the cyclic carbonate having a fluorine atom, and an upper limit thereof is preferably 40% by volume or less, more preferably 30% by volume or less, and still more preferably 15% by volume or less. When the foregoing content falls within the aforementioned range, the electrochemical characteristics in the high-temperature environment can be much more improved without impairing the Li ion permeability, and hence, such is especially preferred.

When the nonaqueous solvent includes both ethylene carbonate and the aforementioned cyclic carbonate having an unsaturated bond, the electrochemical characteristics of a surface film formed on the electrode in the high-temperature environment can be improved, and hence, such is preferred. The content of ethylene carbonate and the aforementioned cyclic carbonate having an unsaturated bond is preferably 3% by volume or more, more preferably 5% by volume or more, and still more preferably 7% by volume or more relative to the total volume of the nonaqueous solvent, and an upper limit thereof is preferably 45% by volume or less, more preferably 35% by volume or less, and still more preferably 25% by volume or less.

These solvents may be used solely; in the case where a combination of two or more of the solvents is used, the effect for improving the electrochemical characteristics in the high-temperature environment is more improved, and hence, such is preferred; and the use of a combination of three or more thereof is especially preferred. As a suitable combination of these cyclic carbonates, EC and PC; EC and VC; PC and VC; VC and FEC; EC and FEC; PC and FEC; FEC and DFEC; EC and DFEC; PC and DFEC; VC and DFEC; VEC and DFEC; VC and EEC; EC and EEC; EC, PC and VC; EC, PC and FEC; EC, VC and FEC; EC, VC and VEC; EC, VC and EEC; EC, EEC and FEC; PC, VC and FEC; EC, VC and DFEC; PC, VC and DFEC; EC, PC, VC and FEC; EC, PC, VC and DFEC; and the like are preferred. Among the aforementioned combinations, a combination, such as EC and VC; EC and FEC; PC and FEC; EC, PC and VC; EC, PC and FEC; EC, VC and FEC; EC, VC and EEC; EC, EEC and FEC; PC, VC and FEC; EC, PC, VC and FEC; etc., is more preferred.

As the linear ester, there are suitably exemplified one or more asymmetric linear carbonates selected from methyl ethyl carbonate (MEC), methyl propyl carbonate (MPC), methyl isopropyl carbonate (MIPC), methyl butyl carbonate, and ethyl propyl carbonate; one or more symmetric linear carbonates selected from dimethyl carbonate (DMC), diethyl carbonate (DEC), dipropyl carbonate, and dibutyl carbonate; and one or more linear carboxylic acid esters selected from pivalate esters, such as methyl pivalate, ethyl pivalate, propyl pivalate, etc., methyl propionate (MP), ethyl propionate (EP), propyl propionate (PP), methyl acetate, and ethyl acetate (EA).

Among the aforementioned linear esters, linear esters having a methyl group selected from dimethyl carbonate (DMC), methyl ethyl carbonate (MEC), methyl propyl carbonate (MPC), methyl isopropyl carbonate (MIPC), methyl butyl carbonate, methyl propionate, and methyl acetate, and besides, ethyl acetate (EA), ethyl propionate (EP), and propyl propionate (PP) are preferred, and linear carbonates having a methyl group are especially preferred.

In the case of using a linear carbonate, it is preferred that two or more thereof are used. Furthermore, it is more preferred that both a symmetric linear carbonate and an asymmetric linear carbonate are included, and it is still more preferred that the symmetric linear carbonate is included in an amount more than the asymmetric linear carbonate.

Though the content of the linear ester is not particularly limited, it is preferred to use the linear ester in an amount in the range of from 60 to 90% by volume relative to the total volume of the nonaqueous solvent. When the foregoing content is 60% by volume or more, the viscosity of the nonaqueous electrolytic solution does not become excessively high, and when it is 90% by volume or less, there is less concern that an electroconductivity of the nonaqueous electrolytic solution is decreased, whereby the electrochemical characteristics are worsened, and therefore, it is preferred that the content of the linear ester falls within the aforementioned range.

A proportion of the volume of the symmetric linear carbonate occupying in the linear carbonate is preferably 51% by volume or more, and more preferably 65% by volume or more. An upper limit thereof is more preferably 95% by volume or less, and still more preferably 85% by volume or less. It is especially preferred that dimethyl carbonate (DMC) is included in the symmetric linear carbonate. In addition, it is more preferred that the asymmetric linear carbonate has a methyl group, and methyl ethyl carbonate (MEC) is especially preferred. In the aforementioned case, the electrochemical characteristics in the high-temperature environment are much more improved, and hence, such is preferred.

As for a proportion of the cyclic carbonate and the linear ester, from the viewpoint of improving the electrochemical characteristics at a high temperature, a ratio of the cyclic carbonate to the linear ester (volume ratio) is preferably 10/90 to 45/55, more preferably 15/85 to 40/60, and especially preferably 20/80 to 35/66.

In the present invention, in addition to the aforementioned nonaqueous solvents, other nonaqueous solvents may be added. As other nonaqueous solvents, there are suitably exemplified one or more selected from a cyclic ether, such as tetrahydrofuran, 2-methyltetrahydrofuran, 1,4-dioxane, etc.; a linear ether, such as 1,2-dimethoxyethane, 1,2-diethoxyethane, 1,2-dibutoxyethane, etc.; an amide, such as dimethylformamide, etc.; a sulfone, such as sulfolane, etc.; and a lactone, such as γ-butyrolactone (GBL), γ-valerolactone, α-angelicalactone, etc.

The content of other nonaqueous solvents is generally 1% or more, and preferably 2% or more, and generally 40% or less, preferably 30% or less, and more preferably 20% or less relative to the total volume of the nonaqueous solvent.

The aforementioned other nonaqueous solvents are generally mixed and used for the purpose of achieving appropriate physical properties. As for a combination thereof, for example, there are suitably exemplified a combination of a cyclic carbonate and a linear carbonate; a combination of a cyclic carbonate and a linear carboxylic acid ester; a combination of a cyclic carbonate, a linear ester (especially a linear carbonate), and a lactone; a combination of a cyclic carbonate, a linear ester (especially a linear carbonate), and an ether; a combination of a cyclic carbonate, a linear carbonate, and a linear carboxylic acid ester; and the like; and a combination of a cyclic carbonate, a linear ester, and a lactone is more preferred. Among the lactones, the use of γ-butyrolactone (GBL) is still more preferred.

For the purpose of much more improving the electrochemical characteristics in the high-temperature environment, it is possible to further add other additives in the nonaqueous electrolytic solution.

As specific examples of other additives, there are suitably exemplified compounds of the following (A) to (G).

(A) One or more nitriles selected from acetonitrile, propionitrile, succinonitrile, glutaronitrile, adiponitrile, pimelonitrile, suberonitrile, and sebaconitrile.

(B) Aromatic compounds having a branched alkyl group, such as cyclohexylbenzene, tert-butylbenzene, tert-amylbenzene, 1-fluoro-4-tert-butylbenzene, etc., and aromatic compounds, such as biphenyl, terphenyl (including o-, m-, and p-forms), fluorobenzene, methyl phenyl carbonate, ethyl phenyl carbonate, diphenyl carbonate, etc.

(C) One or more isocyanate compounds selected from methyl isocyanate, ethyl isocyanate, butyl isocyanate, phenyl isocyanate, tetramethylene diisocyanate, hexamethylene diisocyanate, octamethylene diisocyanate, 1,4-phenylene diisocyanate, 2-isocyanatoethyl acrylate, and 2-isocyanatoethyl methacrylate.

(D) One or more cyclic or linear S═O group-containing compounds selected from sultones, such as 1,3-propanesultone, 1,3-butanesultone, 2,4-butanesultone, 1,4-butanesultone, 1,3-propenesultone, 2,2-dioxide-1,2-oxathiolane-4-yl acetate, etc.; cyclic sulfites, such as ethylene sulfite, etc.; cyclic sulfates, such as ethylene sulfate, [4,4′-bis(1,3,2-dioxathiolane)]2,2,2′,2′-tetraoxide, (2,2-dioxido-1,3,2-dioxathiolane-4-yl)methyl methanesulfonate, 4-((methylsulfonyl)methyl)-1,3,2-dioxathiolane 2,2-dioxide, etc.; sulfonic acid esters, such as butane-2,3-diyl dimethanesulfonate, butane-1,4-diyl dimethanesulfonate, methylene methanedisulfonate, etc.; and vinylsulfone compounds, such as divinylsulfone, 1,2-bis(vinylsulfonyl)ethane, bis(2-vinylsulfonylethyl) ether, etc.

(E) One or more phosphorus-containing compounds selected from trimethyl phosphate, tributyl phosphate, trioctyl phosphate, tris(2,2,2-trifluoroethyl) phosphate, ethyl 2-(diethoxyphosphoryl)acetate, and 2-propynyl 2-(diethoxyphosphoryl)acetate.

(F) Linear carboxylic acid anhydrides, such as acetic anhydride, propionic anhydride, etc., and cyclic acid anhydrides, such as succinic anhydride, maleic anhydride, 3-allylsuccinic anhydride, glutaric anhydride, itaconic anhydride, 3-sulfo-propionic anhydride, etc.

(G) Cyclic phosphazene compounds, such as methoxypentafluorocyclotriphosphazene, ethoxypentafluorocyclotriphosphazene, phenoxypentafluorocyclotriphosphazene, ethoxyheptafluorocyclotetraphosphazene, etc.

Of the foregoing, when at least one selected from the nitriles (A), the aromatic compounds (B), and the isocyanate compounds (C) is included, the electrochemical characteristics in the high-temperature environment are much more improved, and hence, such is preferred.

Of the nitriles (A), one or more selected from succinonitrile, glutaronitrile, adiponitrile, and pimelonitrile are more preferred.

Of the aromatic compounds (B), one or more selected from biphenyl, terphenyl (including o-, m-, and p-forms), fluorobenzene, cyclohexylbenzene, tert-butylbenzene, and tert-amylbenzene are more preferred; and one or more selected from biphenyl, o-terphenyl, fluorobenzene, cyclohexylbenzene, and tert-amylbenzene are especially preferred.

Of the isocyanate compounds (C), one or more selected from hexamethylene diisocyanate, octamethylene diisocyanate, 2-isocyanatoethyl acrylate, and 2-isocyanatoethyl methacrylate are more preferred.

The content of each of the aforementioned compounds (A) to (C) is preferably 0.01 to 7% by mass in the nonaqueous electrolytic solution. When the content falls within this range, a surface film is sufficiently formed without causing an excessive increase of the thickness, and the electrochemical characteristics in the high-temperature environment are much more enhanced. The foregoing content is more preferably 0.05% by mass or more, and still more preferably 0.1% by mass or more in the nonaqueous electrolytic solution, and an upper limit thereof is more preferably 5% by mass or less, and still more preferably 3% by mass or less.

When the cyclic or linear S═O group-containing compound (D) selected from sultones, cyclic sulfites, cyclic sulfates, sulfonic acid esters, and vinylsulfones, the phosphorus-containing compound (E), the cyclic acid anhydride (F), or the cyclic phosphazene compound (G) is included, the electrochemical characteristics in the high-temperature environment are much more improved, and hence, such is preferred.

As the aforementioned cyclic S═O group-containing compound, one or more selected from 1,3-propanesultone, 1,3-butanesultone, 1,4-butanesultone, 2,4-butanesultone, 1,3-propenesultone, 2,2-dioxide-1,2-oxathiolane-4-yl acetate, methylene methanedisulfonate, ethylene sulfite, and ethylene sulfate are suitably exemplified.

As the linear S═O group-containing compound, one or more selected from butane-2,3-diyl dimethanesulfonate, butane-1,4-diyl dimethanesulfonate, dimethyl methanedisulfonate, pentafluorophenyl methanesulfonate, divinylsulfone, and bis(2-vinylsulfonylethyl) ether are suitably exemplified.

Of the aforementioned cyclic or linear S═O group-containing compounds, one or more selected from 1,3-propanesultone, 1,4-butanesultone, 2,4-butanesultone, 2,2-dioxide-1,2-oxathiolane-4-yl acetate, ethylene sulfate, pentafluorophenyl methanesulfonate, and divinylsulfone are more preferred.

As the phosphorus-containing compound (E), tris(2,2,2-trifluoroethyl) phosphate, tris(1,1,1,3,3,3-hexafluoropropan-2-yl) phosphate, methyl 2-(dimethylphosphoryl)acetate, ethyl 2-(dimethylphosphoryl)acetate, methyl 2-(diethylphosphoryl)acetate, ethyl 2-(diethylphosphoryl)acetate, 2-propynyl 2-(dimethylphosphoryl)acetate, 2-propynyl 2-(diethylphosphoryl)acetate, methyl 2-(dimethoxyphosphoryl)acetate, ethyl 2-(dimethoxyphosphoryl)acetate, methyl 2-(diethoxyphosphoryl)acetate, ethyl 2-(diethoxyphosphoryl)acetate, 2-propynyl 2-(dimethoxyphosphoryl)acetate, and 2-propynyl 2-(diethoxyphosphoryl)acetate are preferred; and tris(2,2,2-trifluoroethyl) phosphate, tris(1,1,1,3,3,3-hexafluoropropan-2-yl) phosphate, ethyl 2-(diethylphosphoryl)acetate, 2-propynyl 2-(dimethylphosphoryl)acetate, 2-propynyl 2-(diethylphosphoryl)acetate, ethyl 2-(diethoxyphosphoryl)acetate, 2-propynyl 2-(dimethoxyphosphoryl)acetate, and 2-propynyl 2-(diethoxyphosphoryl)acetate are more preferred.

As the cyclic acid anhydride (F), succinic anhydride, maleic anhydride, and 3-allylsuccinic anhydride are preferred, and succinic anhydride and 3-allylsuccinic anhydride are more preferred.

As the cyclic phosphazene compound (G), cyclic phosphazene compounds, such as methoxypentafluorocyclotriphosphazene, ethoxypentafluorocyclotiphosphazene, phenoxypentafluorocyclotriphoephazene, etc., are preferred, and methoxypentafluorocyclotriphosphazene and ethoxypentafluorocyclotriphosphazene are more preferred.

The content of each of the aforementioned compounds (D) to (G) is preferably 0.001 to 5% by mass in the nonaqueous electrolytic solution. When the content falls within this range, a surface film is sufficiently formed without causing an excessive increase of the thickness, and the electrochemical characteristics in the high-temperature environment are much more enhanced. The foregoing content is more preferably 0.01% by mass or more, and still more preferably 0.1% by mass or more in the nonaqueous electrolytic solution, and an upper limit thereof is more preferably 3% by mass or less, and still more preferably 2% by mass or less.

For the purpose of much more improving the electrochemical characteristics in the high-temperature environment, it is preferred that at least one selected from lithium salts having an oxalate structure, lithium salts having a phosphate structure, and lithium salts having an S═O group is further included in the nonaqueous electrolytic solution.

As specific examples of the lithium salt, there are suitably exemplified at least one lithium salt having an oxalate structure, which is selected from lithium bis(oxalate)borate [LiBOB], lithium difluoro(oxalate)borate [LiDFOB], lithium tetrafluoro(oxalate)phosphate [LiTFOP], and lithium difluorobis(oxalate)phosphate [LiDFOP]; a lithium salt having a phosphate structure, such as LiPO₂F₂, Li₂PO₃F, etc.; and at least one lithium salt having an S═O group, which is selected from lithium trifluoro((methanesulfonyl)oxy)borate [LiTFMSB], lithium pentafluoro((methanesulfonyl)oxy)phosphate [LiPFMSP], lithium methyl sulfate [LMS], lithium ethyl sulfate [LES], lithium 2,2,2-trifluoroethyl sulfate [LFES], and FSO₃Li. Among those, it is more preferred that a lithium salt selected from LiBOB, LiDFOB, LiTFOP, LiDFOP, LiPO₂F₂, LiTFMSB, LMS, LES, LFES, and FSO₃Li is included.

A proportion of the aforementioned lithium salt occupying in the nonaqueous solvent is preferably 0.001 M or more and 0.5 M or less. When the proportion falls within this range, the effect for improving the electrochemical characteristics in the high-temperature environment is much more exhibited. The proportion is preferably 0.01 M or more, more preferably 0.03 M or more, and still more preferably 0.04 M or more. An upper limit thereof is 0.4 M or less, and more preferably 0.2 M or less (wherein M expresses mol/L).

(Electrolyte Salt)

As the electrolyte salt which is used in the present invention, there are suitably exemplified the following lithium salts.

As the lithium salt, at least one lithium salt selected from inorganic lithium salts, such as LiPF_{R}, LiBF₄, LiClO₄, LiN(SO₂F). [LiFSI], etc.; linear fluoroalkyl group-containing lithium salts, such as LiN(SO₂CF₃)₂, LiN(SO₂C₂F₅)₂, LiCF₃SO₃, LiC(SO₂CF₃)₃, LiPF₄(CF₃)₂, LiPF₃(C₂F₅), LiPF₃(CF₃), LiPF₃(iso-C₃F₇)₃, LiPF₅(iso-C₃F₇), etc.; lithium salts having a cyclic fluoroalkylene chain, such as (CF₂)₂(SO₂)₂NLi, (CF₂)₃(SO₂)₂NLi, etc.; and the like is suitably exemplified. These may be used solely or in admixture of two or more thereof.

Among those, one or more selected from LiPF₆, LiBF₄, LiN(SO₂F)₂ [LiFSI], LiN(SO₂CF₃)₂, and LiN(SO₂C₂F₅)₂ are preferred, and the use of LiPF₆ is most preferred.

In general, the concentration of the electrolyte salt is preferably 0.3 M or more, more preferably 0.7 M or more, and still more preferably 1.1 M or more relative to the aforementioned nonaqueous solvent. In addition, an upper limit thereof is preferably 2.5 M or less, more preferably 2.0 M or less, and still more preferably 1.6 M or less.

As for a suitable combination of these electrolyte salts, the case of including LiPF₆ and further including at least one lithium salt selected from LiBF₄, LiN(SO₂CF₃)₂, and LiN(SO₂F)₂ [LiFSI] in the nonaqueous electrolytic solution is preferred. When the proportion of the lithium salt other than LiPF₆ occupying in the nonaqueous solvent is 0.001 M or more, the effect for improving the electrochemical characteristics in the high-temperature environment is readily exhibited, and when it is 1.0 M or less, there is less concern that the effect for improving the electrochemical characteristics in the high-temperature environment is worsened, and hence, such is preferred. The proportion is preferably 0.01 M or more, more preferably 0.03 M or more, and still more preferably 0.04 M or more. An upper limit thereof is preferably 0.8 M or less, more preferably 0.6 M or less, and still more preferably 0.4 M or less.

### [Production of Nonaqueous Electrolytic Solution]

The nonaqueous electrolytic solution of the present invention can be obtained, for example, by mixing the aforementioned nonaqueous solvent, adding 1,3-dioxane and the compound having a carbon-carbon triple bond represented by the general formula (I) to the foregoing electrolyte salt and nonaqueous electrolytic solution.

At this time, the nonaqueous solvent to be used and the compound represented by the general formula (I) to be added to the nonaqueous electrolytic solution, are preferably purified in advance to decrease impurities as far as possible within the range where the productivity is not remarkably worsened.

The nonaqueous electrolytic solution of the present invention may be used in first to fourth energy storage devices shown below, and as the nonaqueous electrolyte, not only one in the form of a liquid but also one in the form of a gel may be used. Furthermore, the nonaqueous electrolytic solution of the present invention may also be used for a solid polymer electrolyte. Above all, the nonaqueous electrolytic solution is preferably used in the first energy storage device using a lithium salt as the electrolyte salt (namely, for a lithium battery) or in the fourth energy storage device (namely, for a lithium ion capacitor), more preferably used in a lithium battery, and most preferably used in a lithium secondary battery.

### [First Energy Storage Device (Lithium Battery)]

The lithium battery that is the first energy storage device is a generic name for a lithium primary battery and a lithium secondary battery. The term “lithium secondary battery” is used as a concept also including a so-called lithium ion secondary battery.

The lithium battery of the present invention includes a positive electrode, a negative electrode, and the aforementioned nonaqueous electrolytic solution having an electrolyte salt dissolved in a nonaqueous solvent. Other constitutional members than the nonaqueous electrolytic solution, such as the positive electrode, the negative electrode, etc., may be used without being particularly limited.

For example, as a positive electrode active material for a lithium secondary battery, a complex metal oxide of lithium containing one or more selected from the group consisting of cobalt, manganese, and nickel is used. These positive electrode active materials may be used solely or in combination of two or more thereof.

As such a lithium complex metal oxide, for example, one or more selected from LiCoO₂, LiCo₁₋ₓMₓO₂ (wherein M is one or more elements selected from Sn, Mg, Fe, Ti, Al, Zr, Cr, V, Ga, Zn, and Cu; and 0.001≤x≤0.05), LiMn₂O₄, LiNiO₂, LiCo₁₋ₓNiₓO₂ (0.01<x<1), LiCo_{1/3}Ni_{1/3}Mn_{1/3}O₂, LiNi_{0.5}Mn_{0.3}Co_{0.2}O₂, LiNi_{0.6}Mn_{0.2}Co_{0.2}O₂, LiNi_{0.8}Mn_{0.1}Co_{0.1}O₂, LiNi_{0.8}Co_{0.15}Al_{0.05}O₂, a solid solution of Li₂MnO₃ and LiMO₂ (wherein M is a transition metal, such as Co, Ni, Mn, Fe, etc.), and LiNi_{1/2}Mn_{3/2}O₄ are more preferred. In addition, these materials may also be used as a combination, such as a combination of LiCoO₂ and LiMn₂O₄, a combination of LiCoO₂ and LiNiO₂, and a combination of LiMn₂O₄ and LiNiO₂.

In general, when the lithium complex metal oxide capable of acting at a higher charged voltage is used, the electrochemical characteristics in the high-temperature environment is liable to be worsened due to the reaction with the electrolytic solution on charging; however, in the lithium secondary battery according to the present invention, worsening of such electrochemical characteristics can be suppressed.

In particular, when a positive electrode active material including Ni is used, in general, decomposition of the nonaqueous solvent occurs on the surface of the positive electrode due to a catalytic action of Ni, so that the resistance of the battery tends to readily increase. In particular, though the electrochemical characteristics in the high-temperature environment are liable to be worsened, in the lithium secondary battery according to the present invention, worsening of such electrochemical characteristics can be suppressed, and hence, such is preferred. In particular, in the case of using a positive electrode active material in which a proportion of the atomic concentration of Ni is more than 10 atomic % relative to the atomic concentration of all of transition metal elements in the positive electrode active material, the aforementioned effect becomes remarkable, and hence, such is preferred. The use of 20 atomic % or more of the positive electrode active material is more preferred, and the use of 30 atomic % or more of the positive electrode active material is still more preferred. Specifically, one or more selected from LiCo_{1/3}Ni_{1/3}Mn_{1/3}O₂, LiNi_{0.5}Mn_{0.3}Co_{0.2}O₂, LiNi_{0.6}Mn_{0.2}Co_{0.2}O₂, LiNi_{0.8}Mn_{0.1}Co_{0.1}O₂, and LiNi_{0.8}Co_{0.15}Al_{0.05}O₂ are suitably exemplified.

Furthermore, a lithium-containing olivine-type phosphate may also be used as the positive electrode active material. In particular, a lithium-containing olivine-type phosphate including at least one selected from iron, cobalt, nickel, and manganese is preferred. Specific examples thereof include one or more selected from LiFePO₄, LiCoPO₄, LiNiPO₄, LiMnPO₄, and LiFe₁₋ₓMnₓPO₄ (0.1<x<0.9).

A part of such a lithium-containing olivine-type phosphate may be substituted with other element. A part of iron, cobalt, nickel, or manganese may be substituted with one or more elements selected from Co, Mn, Ni, Mg, Al, B, Ti, V, Nb, Cu, Zn, Mo, Ca, Sr, W, Zr, and the like, or the lithium-containing olivine-type phosphate may also be coated with a compound containing any of these other elements or with a carbon material. Among those, LiFePO₄ and LiMnPO₄ are preferred.

The lithium-containing olivine-type phosphate may also be used, for example, in admixture with the aforementioned positive electrode active material.

The lithium-containing olivine-type phosphate forms a stable phosphate skeleton (PO₄) structure and is excellent in thermal stability on charging, and therefore, the charging storage properties and the discharging storage properties in the high-temperature environment can be improved.

Examples of the positive electrode for a lithium primary battery include an oxide or chalcogen compound of one or more metal elements, such as CuO, Cu₂O, Ag₂O, Ag₂CrO₄, CuS, CuSO₄, TiO₂, TiS₂, SiO₂, SnO, V₂O₅, V₆O₁₂, VOₓ, Nb₂O₅, Bi₂O₃, Bi₂Pb₂O₆, Sb₂O₃, CrO₃, Cr₂O₃, MoO₃, WO₃, SeO₃, MnO₂, Mn₂O₃, Fe₂O₃, FeO, Fe₃O₄, Ni₂O₃, NiO, CoO₃, CoO, and the like; a sulfur compound, such as SO₂, SOCl₂, etc.; a carbon fluoride (graphite fluoride) represented by a general formula (CFₓ)ₙ; and the like. Among those, MnO₂, V₂O₅, graphite fluoride, and the like are preferred.

An electroconductive agent of the positive electrode is not particularly limited so long as it is an electron-conductive material which does not undergo chemical change. Examples thereof include graphites, such as natural graphite (e.g., flaky graphite, etc.), artificial graphite, etc.; carbon blacks, such as acetylene black, Ketjen black, channel black, furnace black, lamp black, thermal black, etc.; and the like. In addition, the graphite and the carbon black may be appropriately mixed and used. The amount of the electroconductive agent added to a positive electrode mixture is preferably 1 to 10% by mass, and especially preferably 2 to 5% by mass.

The positive electrode can be produced in such a manner that the aforementioned positive electrode active material is mixed with an electroconductive agent, such as acetylene black, carbon black, etc., and then mixed with a binder, such as polytetrafluoroethylene (PTFE), polyvinylidene fluoride (PVDF), a copolymer of styrene and butadiene (SBR), a copolymer of acrylonitrile and butadiene (NBR), carboxymethyl cellulose (CMC), an ethylene-propylene-diene terpolymer, etc., to which is then added a high-boiling point solvent, such as 1-methyl-2-pyrrolidone, etc., followed by kneading to provide a positive electrode mixture, and this positive electrode mixture is applied onto a collector, such as an aluminum foil, a stainless steel-made lath plate, etc., dried, shaped under pressure, and then heat-treated in vacuum at a temperature of about 50° C. to 250° C. for about 2 hours.

A density of the positive electrode except for the collector is generally 1.5 g/cm³ or more, and for the purpose of further increasing a capacity of the battery, the density is preferably 2 g/cm³ or more, more preferably 3 g/cm³ or more, and still more preferably 3.6 g/cm³ or more. In addition, an upper limit thereof is preferably 4 g/cm³ or less.

As a negative electrode active material for a lithium secondary battery, one or more selected from metal lithium, a lithium alloy, a carbon material capable of absorbing and releasing lithium [e.g., graphitizable carbon, non-graphitizable carbon having a spacing of a (002) plane of 0.37 nm or more, graphite having a spacing of a (002) plane of 0.34 nm or less, etc.], tin (elemental substance), a tin compound, silicon (elemental substance), a silicon compound, a lithium titanate compound, such as Li₄Ti₅O₁₂, etc., and the like are exemplified.

Among those, in the ability of absorbing and releasing a lithium ion, the use of a high-crystalline carbon material, such as artificial graphite, natural graphite, etc., is more preferred, and the use of a carbon material having a graphite-type crystal structure in which a lattice (002) spacing (d₀₀₂) is 0.340 nm (nanometers) or less, and especially from 0.335 to 0.337 nm, is still more preferred.

In particular, the use of artificial graphite particles having a bulky structure containing plural flattened graphite fine particles which are aggregated or bonded non-parallel to each other, or graphite particles produced through a spheroidizing treatment of flaky natural graphite particles by repeatedly applying a mechanical action, such as a compression force, a friction force, a shear force, etc., is preferred.

When a ratio I(110)/I(004) of a peak intensity I(110) of a (110) plane to a peak intensity I(004) of a (004) plane of the graphite crystal obtained through X-ray diffractometry of a negative electrode sheet at the time of shaping under pressure to such an extent that a density of the negative electrode except for the collector is 1.5 g/cm³ or more is 0.01 or more, the metal elution amount from the positive electrode active material and the charging storage properties are much more improved, and hence, such is preferred. The ratio I(110)/I(004) is more preferably 0.05 or more, and still more preferably 0.1 or more. In addition, an upper limit thereof is preferably 0.5 or less, and more preferably 0.3 or less because there may be the case where the crystallinity is worsened to lower the discharge capacity of the battery due to an excessive treatment.

When the high-crystalline carbon material (core material) is coated with a carbon material having lower crystallinity than the core material, the electrochemical characteristics in the high-temperature environment become much more favorable, and hence, such is preferred. The crystallinity of the carbon material in the coating may be confirmed through TEM.

When the high-crystalline carbon material is used, there is a tendency that it reacts with the nonaqueous electrolytic solution on charging, thereby worsening the electrochemical characteristics at a low temperature or a high temperature due to an increase of interfacial resistance. However, in the lithium secondary battery according to the present invention, the electrochemical characteristics in the high-temperature environment become favorable.

Examples of the metal compound capable of absorbing and releasing lithium as a negative electrode active material include compounds containing at least one metal element, such as Si, Ge, Sn, Pb, P, Sb, Bi, Al, Ga, In, Ti, Mn, Fe, Co, Ni, Cu, Zn, Ag, Mg, Sr, Ba, etc. Such a metal compound may be in any form including an elemental substance, an alloy, an oxide, a nitride, a sulfide, a boride, an alloy with lithium, and the like, and any of an elemental substance, an alloy, an oxide, and an alloy with lithium are preferred because the battery capacity can be increased. Among those, a compound containing at least one element selected from Si, Ge, and Sn is preferred, and a compound containing at least one element selected from Si and Sn is especially preferred because the battery capacity can be increased.

The negative electrode can be produced in such a manner that the same electroconductive agent, binder, and high-boiling point solvent as in the production of the positive electrode as described above are used and kneaded to provide a negative electrode mixture, and the negative electrode mixture is then applied onto a collector, such as a copper foil, etc., dried, shaped under pressure, and then heat-treated in vacuum at a temperature of about 50° C. to 250° C. for about 2 hours.

A density of the negative electrode except for the collector is generally 1.1 g/cm or more, and for the purpose of further increasing a capacity of the battery, the density is preferably 1.5 g/cm³ or more, and especially preferably 1.7 g/cm³ or more. An upper limit thereof is preferably 2 g/cm³ or less.

Examples of the negative electrode active material for a lithium primary battery include metal lithium and a lithium alloy.

The structure of the lithium battery is not particularly limited, and may be a coin-type battery, a cylinder-type battery, a prismatic battery, a laminate-type battery, or the like, each having a single-layered or multi-layered separator.

The separator for the battery is not particularly limited, and a single-layered or laminated micro-porous film of a polyolefin, such as polypropylene, polyethylene, an ethylene-propylene copolymer, etc., a woven fabric, a nonwoven fabric, and the like may be used.

As the laminate of a polyolefin, a laminate of polyethylene and polypropylene is preferred, and a three-layer structure of polypropylene/polyethylene/polypropylene is more preferred.

The thickness of the separator is preferably 2 μm or more, more preferably 3 μm or more, and still more preferably 4 μm or more, and an upper limit thereof is 30 μm or less, preferably 20 μm or less, and more preferably 15 μm or less.

The lithium secondary battery in the present invention has excellent electrochemical characteristics in the high-temperature environment even when a final charging voltage is 4.2 V or more, particularly 4.3 V or more, and furthermore, the characteristics are favorable even at 4.4 V or more. A final discharging voltage may be generally 2.8 V or more, and further 2.5 V or more; however, the final discharging voltage of the lithium secondary battery in the present invention may be 2.0 V or more. An electric current value is not particularly limited, and in general, the battery is used within a range of from 0.1 to 30 C. In addition, the lithium battery in the present invention can be charged and discharged at from −40 to 100° C., and preferably from −10 to 80° C.

In the present invention, as a countermeasure against the increase in the internal pressure of the lithium battery, there may also be adopted such a method that a safety valve is provided in a battery cap, or a cutout is provided in a component, such as a battery can, a gasket, etc. In addition, as a safety countermeasure for prevention of overcharging, a circuit cut-off mechanism capable of detecting the internal pressure of the battery to cut off the current may be provided in the battery cap.

### [Second Energy Storage Device (Electric Double Layer Capacitor)]

The second energy storage device of the present invention is an energy storage device including the nonaqueous electrolytic solution of the present invention and storing energy by utilizing an electric double layer capacity in an interface between the electrolytic solution and the electrode. One example of the present invention is an electric double layer capacitor. A most typical electrode active material which is used in this energy storage device is active carbon. The double layer capacity increases substantially in proportion to a surface area.

### [Third Energy Storage Device]

The third energy storage device of the present invention is an energy storage device including the nonaqueous electrolytic solution of the present invention and storing energy by utilizing a doping/dedoping reaction of the electrode. Examples of the electrode active material which is used in this energy storage device include a metal oxide, such as ruthenium oxide, iridium oxide, tungsten oxide, molybdenum oxide, copper oxide, etc., and a π-conjugated polymer, such as polyacene, a polythiophene derivative, etc. A capacitor using such an electrode active material is capable of storing energy following the doping/dedoping reaction of the electrode.

### [Fourth Energy Storage Device (Lithium Ion Capacitor)]

The fourth energy storage device of the present invention is an energy storage device including the nonaqueous electrolytic solution of the present invention and storing energy by utilizing intercalation of a lithium ion into a carbon material, such as graphite, etc., as the negative electrode. This energy storage device is called a lithium ion capacitor (LIC). As the positive electrode, there are suitably exemplified one utilizing an electric double layer between an active carbon electrode and an electrolytic solution, one utilizing a doping/dedoping reaction of a r-conjugated polymer electrode, and the like. The electrolytic solution includes at least a lithium salt, such as LiPF₆, etc.

### EXAMPLES

Examples of an electrolytic solution using the compound of the present invention are hereunder described, but it should be construed that the present invention is not limited to these Examples.

### Examples 1 to 18 and Comparative Examples 1 to 6

### [Production of Lithium Ion Secondary Battery]

92% by mass of LiNi_{0.33}Co_{0.33}Mn_{0.34}O₂ and 5% by mass of acetylene black (electroconductive agent) were added to and mixed with a solution which had been prepared by dissolving 3% by mass of polyvinylidene fluoride (binder) in 1-methyl-2-pyrrolidone in advance, thereby preparing a positive electrode mixture paste. This positive electrode mixture paste was applied onto one surface of an aluminum foil (collector), dried, and treated under pressure, followed by cutting into a predetermined size, thereby producing a positive electrode sheet. A density of the positive electrode except for the collector was 3.6 g/cm³.

5% by mass of silicon (elemental substance) and 90% by mass of artificial graphite (d₀₀₂=0.335 nm, negative electrode active material) were added to and mixed with a solution which had been prepared by dissolving 5% by mass of polyvinylidene fluoride (binder) in 1-methyl-2-pyrrolidone in advance, thereby preparing a negative electrode mixture paste. This negative electrode mixture paste was applied onto one surface of a copper foil (collector), dried, and treated under pressure, followed by cutting into a predetermined size, thereby producing a negative electrode sheet. A density of the negative electrode except for the collector was 1.5 g/cm³. In addition, this electrode sheet was used and analyzed by X-ray diffractometry. As a result, a ratio [I(110)/I(004)] of the peak intensity I(110) of the (110) plane to the peak intensity I(004) of the (004) plane of the graphite crystal was 0.1.

The positive electrode sheet, a micro-porous polyethylene film-made separator, and the negative electrode sheet were laminated in this order, and a nonaqueous electrolytic solution having each of compositions shown in Tables 1 and 2 was added, thereby producing a laminate-type battery.

### [Evaluation of High-Temperature Charging Storage Properties]

### <Initial Discharge Capacity and Impedance>

In a thermostatic chamber at 25° C., the laminate-type battery produced by the aforementioned method was used and charged up to a final voltage of 4.2 V with a constant current of 0.2 C and under a constant voltage for 7 hours and then discharged down to a final voltage of 2.5 V with a constant current of 0.2 C, thereby determining an initial discharge capacity. Thereafter, in a thermostatic chamber at 25° C., an impedance at 1 kHz was measured, thereby determining an initial impedance.

### <High-Temperature Charging Storage Test>

Subsequently, in a thermostatic chamber at 60° C., this laminate-type battery was charged up to a final voltage of 4.2 V with a constant current of 0.2 C and under a constant voltage for 7 hours and then stored for 7 days in a state of open circuit. Thereafter, the battery was placed in a thermostatic chamber at 25° C., and once discharged down to a final voltage of 2.5 V under a constant current of 1 C.

Subsequently, in a thermostatic chamber at 25° C., the battery was charged up to a final voltage of 4.4 V with a constant current of 0.2 C and under a constant voltage for 7 hours and then discharged down to a final voltage of 2.5 V with a constant current of 0.2 C. thereby determining a recovery discharge capacity after charging storage. A capacity recovery rate after high-temperature charging storage was determined according to the following formula.

Capacity recovery rate (%) after high-temperature charging storage=(Recovered discharge capacity)/(Initial discharge capacity)×100

Furthermore, in a thermostatic chamber at 25° C., a coin-type battery was then measured for an impedance at 1 kHz, thereby determining an impedance after charging storage. An impedance change rate after charging storage was determined according to the following formula.

Impedance change rate (%) after high-temperature charging storage=(Impedance after storage)/(Initial impedance)×100

### [Evaluation of High-Temperature Discharging Storage Properties]

<Metal Elution Amount in Electrolytic Solution after High-Temperature Discharging Storage>

In a thermostatic chamber at 25° C., a laminate-type battery produced in the same manner as in the aforementioned method was used and charged up to a final voltage of 4.2 V with a constant current of 0.2 C and under a constant voltage for 7 hours and then discharged down to a final voltage of 2.5 V with a constant current of 0.2 C.

Subsequently, this laminate-type battery was placed in a thermostat at 80° C. and then stored for 14 days in a state of open circuit. Thereafter, the battery was placed in a thermostatic chamber at 25° C. and thoroughly cooled, and the electrolytic solution was then extracted from the laminate-type battery. Then, the concentration of a Cu ion in the electrolytic solution (metal elution from the negative electrode collector) was quantitatively determined by ICP-MS analysis. As for the metal elution amount after high-temperature discharging storage, a relative value was determined on a basis when the metal elution amount of Comparative Example 1 was defined as 100%.

Production conditions and battery characteristics of each of the batteries are shown in Tables 1 and 2.

The term “PP” used in Example 10 in Table 1 is an abbreviation of propyl propionate.

TABLE 1

| | Composition of | Addition | Compound of general formula (I) | | | | |
|---|---|---|---|---|---|---|---|
| | electrolyte salt | amount of | | Addition | Capacity | Impedance | Metal elution |
| | Composition of | 1,3-dioxane | | amount | recovery rate | change rate | amount after |
| | nonaqueous | (Content in | | (Content in | after high- | after high- | high- |
| | electrolytic | nonaqueous | | nonaqueous | temperature | temperature | temperature |
| | solution | electrolytic | | electrolytic | charging | charging | discharging |
| | (Volume ratio | solution) | | solution) | storage | storage | storage |
| | of solvent) | (% by mass) | Kind | (% by mass) | (%) | (%) | (%) |
| Example 1 | 1.1M LiPF6 EC/DMC/MEC (30/45/25) | 0.2 | 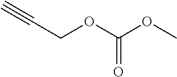 | 0.1 | 75 | 141 | 25 |
| Example 2 | 1.1M LiPF6 | 1.8 | | 1.6 | 79 | 129 | 18 |
| | EC/DMC/MEC | | | | | | |
| | (30/45/25) | | | | | | |
| Example 3 | 1.1M LiPF6 | 2.7 | | 1.6 | 78 | 131 | 21 |
| | EC/DMC/MEC | | | | | | |
| | (30/45/25) | | | | | | |
| Example 4 | 1.1M LiPF6 | 3 | | 0.1 | 77 | 139 | 24 |
| | EC/DMC/MEC | | | | | | |
| | (30/45/25) | | | | | | |
| Example 5 | 1.1M LiPF6 | 3 | | 2.5 | 78 | 133 | 20 |
| | EC/DMC/MEC | | | | | | |
| | (30/45/25) | | | | | | |
| Example 6 | 1.1M LiPF6 | 3 | | 2.8 | 78 | 137 | 24 |
| | EC/DMC/MEC | | | | | | |
| | (30/45/25) | | | | | | |
| Example 7 | 1.1M LiPF6 | 0.2 | | 3 | 72 | 155 | 33 |
| | EC/DMC/MEC | | | | | | |
| | (30/45/25) | | | | | | |
| Example 8 | 1.1M LiPF6 | 1.2 | | 2.8 | 74 | 143 | 31 |
| | EC/DMC/MEC | | | | | | |
| | (30/45/25) | | | | | | |
| Example 9 | 1.1M LiPF6 | 3.6 | | 3.4 | 77 | 136 | 28 |
| | EC/DMC/MEC | | | | | | |
| | (30/45/25) | | | | | | |
| Example 10 | 1.1M LiPF6 | 1.8 | | 1.6 | 80 | 129 | 20 |
| | EC/VC/PP/MEC | | | | | | |
| | (28/2/50/20) | | | | | | |
| Example 11 | 1.0M LiPF6 + | 1.8 | | 1.6 | 81 | 126 | 18 |
| | 0.1M LiPO2F2 | | | | | | |
| | EC/VC/DMC/MEC | | | | | | |
| | (28/2/45/25) | | | | | | |
| Example 12 | 1.0M LiPF6 + 0.1M LES | 1.8 | | 1.6 | 81 | 124 | 17 |
| | EC/VC/DMC/MEC | | | | | | |
| | (28/2/45/25) | | | | | | |
| Example 13 | 0.8M LiPF6 + 0.3M LiFSl | 1.8 | | 1.6 | 80 | 122 | 16 |
| | EC/VC/FEC/DMC/MEC | | | | | | |
| | (23/2/5/45/25) | | | | | | |
| Comparative | 1.1M LiPF6 | None | None | — | 63 | 180 | 100 |
| Example 1 | EC/DMC/MEC | | | | | | |
| | (30/45/25) | | | | | | |
| Comparative | 1.1M LiPF6 | 3 | None | — | 68 | 172 | 99 |
| Example 2 | EC/DMC/MEC | | | | | | |
| | (30/45/25) | | | | | | |
| Comparative Example 3 | 1.1M LiPF6 EC/DMC/MEC (30/45/25) | None | 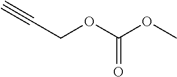 | 2.8 | 70 | 193 | 91 |
| Comparative | 1.1M LiPF6 | 4.4 | | 1.6 | 71 | 154 | 54 |
| Example 4 | EC/DMC/MEC | | | | | | |
| | (30/45/25) | | | | | | |
| Comparative | 1.1M LiPF6 | 1.8 | | 4.4 | 71 | 164 | 63 |
| Example 5 | EC/DMC/MEC | | | | | | |
| | (30/45/25) | | | | | | |
| Comparative Example 6 | 1.1M LiPF6 EC/DMC/MEC (30/45/25) | 3 | 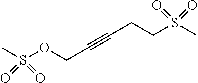 | 2.8 | 71 | 175 | 100 |

TABLE 2

| | Composition of | Addition | Compound of general formula (I) | | | | |
|---|---|---|---|---|---|---|---|
| | electrolyte salt | amount of | | Addition | Capacity | Impedance | Metal elution |
| | Composition of | 1,3-dioxane | | amount | recovery rate | change rate | amount after |
| | nonaqueous | (Content in | | (Content in | after high- | after high- | high- |
| | electrolytic | nonaqueous | | nonaqueous | temperature | temperature | temperature |
| | solution | electrolytic | | electrolytic | charging | charging | discharging |
| | (Volume ratio | solution) | | solution) | storage | storage | storage |
| | of solvent) | (% by mass) | Kind | (% by mass) | (%) | (%) | (%) |
| Example 14 | 1.1M LiPF6 EC/DMC/MEC (30/45/25) | 1.8 | 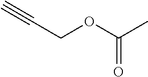 | 1.6 | 76 | 134 | 25 |
| Example 15 | 1.1M LiPF6 EC/DMC/MEC (30/45/25) | 1.8 | 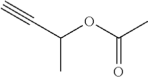 | 1.6 | 75 | 136 | 26 |
| Example 16 | 1.1M LiPF6 EC/DMC/MEC (30/45/25) | 1.8 | 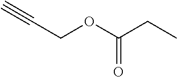 | 1.6 | 76 | 132 | 24 |
| Example 2 | 1.1M LiPF6 EC/DMC/MEC (30/45/25) | 1.8 | 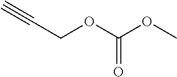 | 1.6 | 79 | 129 | 18 |
| Example 17 | 1.1M LiPF6 EC/DMC/MEC (30/45/25) | 1.8 | 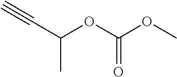 | 1.6 | 78 | 133 | 23 |
| Example 18 | 1.1M LiPF6 EC/DMC/MEC (30/45/25) | 1.8 | 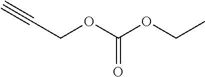 | 1.6 | 78 | 129 | 20 |

### Example 19 and Comparative Example 7

Positive electrode sheets were produced by using LiNi_{0.6}Co_{0.2}Mn_{0.2}O₂ (positive electrode active material) in place of the positive electrode active material used in Example 1. 92% by mass of LiNi_{0.6}Co_{0.2}Mn_{0.2}O₂ and 5% by mass of acetylene black (electroconductive agent) were added to and mixed with a solution which had been prepared by dissolving 3% by mass of polyvinylidene fluoride (binder) in 1-methyl-2-pyrrolidone in advance, thereby preparing a positive electrode mixture paste. Laminate-type batteries were produced and evaluated in the same manners as in Example 1, except that this positive electrode mixture paste was applied onto an aluminum foil (collector), dried, and treated under pressure, followed by cutting into a predetermined size, thereby producing a positive electrode sheet; and that on evaluating the battery, the final charging voltage was set to 4.4 V, and the final discharging voltage was set to 2.5 V.

As for the metal elution amount after high-temperature discharging storage, a relative value was determined on a basis when the metal elution amount of Comparative Example 7 was defined as 100%. The results are shown in Table 3.

TABLE 3

| | Composition of | Addition | Compound of general formula (I) | | | | |
|---|---|---|---|---|---|---|---|
| | electrolyte salt | amount of | | Addition | Capacity | Impedance | Metal elution |
| | Composition of | 1,3-dioxane | | amount | recovery rate | change rate | amount after |
| | nonaqueous | (Content in | | (Content in | after high- | after high- | high- |
| | electrolytic | nonaqueous | | nonaqueous | temperature | temperature | temperature |
| | solution | electrolytic | | electrolytic | charging | charging | discharging |
| | (Volume ratio | solution) | | solution) | storage | storage | storage |
| | of solvent) | (% by mass) | Kind | (% by mass) | (%) | (%) | (%) |
| Example 19 | 1.1M LiPF6 EC/DMC/MEC (30/45/25) | 1.8 | 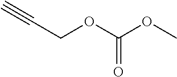 | 1.6 | 79 | 123 | 17 |
| Comparative | 1.1M LiPF6 | None | None | — | 66 | 172 | 100 |
| Example 7 | EC/DMC/MEC | | | | | | |
| | (30/45/25) | | | | | | |

In all of the lithium secondary batteries of the aforementioned Examples 1 to 19, in the nonaqueous electrolytic solution of the present invention, the charging storage properties and the discharging storage properties are remarkably improved as compared with the case of not adding both the 1,3-dioxane and the compound having a carbon-carbon triple bond represented by the aforementioned general formula (I) as in Comparative Example 1, the case of adding either one of the foregoing compounds as in Comparative Examples 2 and 3, the case of adding either one of the foregoing compounds in an amount more excessive than the specified amount of the present invention as in Comparative Examples 4 and 5, and the lithium secondary battery using the nonaqueous electrolytic solution in which 1,3-dioxane and the sulfonic acid ester having a carbon-carbon triple bond as in Comparative Example 6.

In the light of the above, it has become clear that the effect of the present invention is a peculiar effect in the case where a combination of a specified amount of 1,3-dioxane with a specified amount of the compound having a carbon-carbon triple bond represented by the aforementioned general formula (I) according to the present invention is applied to the nonaqueous electrolytic solution having an electrolyte salt dissolved in a nonaqueous solvent.

In addition, from Example 19 and Comparative Example 7, the same effect is brought even in the case of using LiNi_{0.6}Co_{0.2}Mn_{0.2}O₂ for the positive electrode. In consequence, it is evident that the effect of the present invention is not an effect relying on the specified positive electrode or negative electrode.

Furthermore, the nonaqueous electrolytic solution of the present invention also has an effect for improving the charging storage properties and the discharging properties in the high-temperature environment of a lithium primary battery, a lithium ion capacitor, a lithium air battery, and so on.

### INDUSTRIAL APPLICABILITY

By using the nonaqueous electrolytic solution of the present invention, it is possible to obtain an energy storage device which is excellent in electrochemical characteristics in the high-temperature environment. In particular, in the case of being used as a nonaqueous electrolytic solution for an energy storage device to be mounted in a hybrid electric vehicle, a plug-in hybrid electric vehicle, a battery electric vehicle, and so on, it is possible to obtain an energy storage device capable of improving the electrochemical characteristics in the high-temperature environment.

1: A nonaqueous electrolytic solution comprising an electrolyte salt dissolved in a nonaqueous solvent, the nonaqueous electrolytic solution comprising 0.1 to 4% by mass of 1,3-dioxane and 0.1 to 4% by mass of a compound having a carbon-carbon triple bond represented by formula (I): 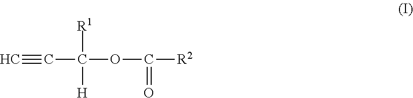
wherein R¹ represents a hydrogen atom or a methyl group, and R² represents an alkyl group selected from the group consisting of a methyl group and an ethyl group, or an alkoxy group selected from the group consisting of a methoxy group and an ethoxy group.

2: The nonaqueous electrolytic solution according to claim 1, wherein the compound represented by the formula (I) is one or more selected from the group consisting of 2-propynyl acetate, 2-propynyl propionate, 2-propynyl methyl carbonate, and 2-propynyl ethyl carbonate.

3: The nonaqueous electrolytic solution according to claim 1, wherein the nonaqueous solvent comprises a cyclic carbonate and a linear ester.

4: The nonaqueous electrolytic solution according to claim 3, wherein the cyclic carbonate comprises one or more selected from the group consisting of ethylene carbonate, propylene carbonate, 4-fluoro-1,3-dioxolan-2-one, vinylene carbonate, and 4-ethynyl-1,3-dioxolan-2-one.

5: The nonaqueous electrolytic solution according to claim 3, wherein the linear ester comprises both a symmetric linear carbonate and an asymmetric linear carbonate, the symmetric linear carbonate being included in an amount more than the asymmetric linear carbonate.

6: An energy storage device comprising a positive electrode, a negative electrode, and the nonaqueous electrolytic solution according to claim 1.

7: The energy storage device according to claim 6, wherein the negative electrode comprises, as a negative electrode active material, one or more selected from the group consisting of metal lithium, a lithium alloy, a carbon material capable of absorbing and releasing lithium, tin, a tin compound, silicon, a silicon compound, and a lithium titanate compound.

8: The energy storage device according to claim 6, wherein the positive electrode comprises, as a positive electrode active material, a complex metal oxide of lithium comprising one or more selected from the group consisting of cobalt, manganese, and nickel, or a lithium-containing olivine-type phosphate.

9: The energy storage device according to claim 6, wherein the energy storage device is a lithium secondary battery or a lithium ion capacitor.

10: The nonaqueous electrolytic solution according to claim 1, wherein the electrolyte salt comprises LiPF₆ and at least one lithium salt selected from the group consisting of LiBF₄, LiN(SO₂CF₃)₂, and LiN(SO₂F)₂.

11: The nonaqueous electrolytic solution according to claim 10, wherein a proportion of the lithium salt other than LiPF₆ in the nonaqueous solvent is 0.001 to 1.0 M.

12: The nonaqueous electrolytic solution according to claim 1, wherein the electrolyte salt comprises at least one lithium salt selected from the group consisting of a lithium salt having an oxalate structure, a lithium salt having a phosphate structure, and a lithium salt having an S═O group.

13: The nonaqueous electrolytic solution according to claim 12, wherein the electrolyte salt comprises the lithium salt having an oxalate structure, which is selected from the group consisting of lithium bis(oxalate)borate, lithium difluoro(oxalate)borate, lithium tetrafluoro(oxalate)phosphate, and lithium difluorobis(oxalate)phosphate.

14: The nonaqueous electrolytic solution according to claim 12, wherein the electrolyte salt comprises the lithium salt having a phosphate structure, which is selected from the group consisting of LiPO₂F₂ and Li₂PO₃F.

15: The nonaqueous electrolytic solution according to claim 12, wherein the electrolyte salt comprises the lithium salt having an S═O group, which is selected from the group consisting of trifluoro((methanesulfonyl)oxy)borate, lithium pentafluoro((methanesulfonyl)oxy)phosphate, lithium methyl sulfate, lithium ethyl sulfate, lithium 2,2,2-trifluoroethyl sulfate, and FSO₃Li.

16: The nonaqueous electrolytic solution according to claim 12, wherein a proportion of the at least one lithium salt in the nonaqueous solvent is 0.001 to 0.5 M.

17: The nonaqueous electrolytic solution according to claim 3, wherein the linear ester comprises one or more selected from the group consisting of an asymmetric linear carbonate, a symmetric linear carbonate, and a linear carboxylic acid ester.

18: The nonaqueous electrolytic solution according to claim 17, wherein:
the asymmetric linear carbonate is one or more selected from the group consisting of methyl ethyl carbonate, methyl propyl carbonate, methyl isopropyl carbonate, methyl butyl carbonate, and ethyl propyl carbonate;
the symmetric linear carbonate is one or more selected from the group consisting of dimethyl carbonate, diethyl carbonate, dipropyl carbonate, and dibutyl carbonate; and
the linear carboxylic acid ester is one or more selected from the group consisting of methyl pivalate, ethyl pivalate, propyl pivalate, methyl propionate, ethyl propionate, propyl propionate, methyl acetate, and ethyl acetate.
